(19) United States
(12) Patent Application Publication
(10) Pub. No.: US 2025/0353690 A1
(43) Pub. Date: Nov. 20, 2025

(54) LOADING APPARATUS AND MAGNETIC LEVITATION CONVEYING APPARATUS WITH AT LEAST ONE SUCH LOADING APPARATUS

(71) Applicant: SOMIC VERPACKUNGSMASCHINEN GMBH & CO. KG, Amerang (DE)

(72) Inventor: Matthias WANDER, Taufkirchen (DE)

(21) Appl. No.: 18/871,730

(22) PCT Filed: Jun. 29, 2022
(86) PCT No.: PCT/EP2022/067894

§ 371 Date: Dec. 4, 2024

(51) Int. Cl. B65G 47/57; B65G 47/252; B65G 54/02

(52) U.S. Cl. CPC B65G 47/57; B65G 47/252; B65G 54/02

(57) ABSTRACT

Disclosed is a loading apparatus and a magnetic levitation conveying apparatus with at least one such loading apparatus. The loading apparatus comprises at least one first stator unit and at least one second stator unit along which movers with receptacles attached thereto can move using magnetic levitation technology. The at least one second stator unit can be inclined relative to the at least one first stator unit between an initial position and a final position. At least one feeding device for feeding products is arranged such that the at least one product can be transferred by gravity from the respective feeding device into the receptacle of the mover when the latter is in an inclined loading position assigned to the respective feeding device, the inclination angle of which is substantially equal to the inclination angle of the at least one second stator unit arranged in the final position.

The invention relates to a loading apparatus for loading a receptacle attached to a mover with at least one product, wherein the mover is part of a conveying apparatus designed using magnetic levitation technology, wherein the loading apparatus comprises the mover with the receptacle attached thereto, at least one feeding device for feeding the at least one product, at least one first stator unit with a first movement surface along which the mover can move, and at least one second stator unit with a second movement surface along which the mover can move, and wherein, in an initial position, the at least one first stator unit and the at least one second stator unit are arranged relative to one another such that the first movement surface and the second movement surface substantially form a common plane.

US 2020/0030995 A1 generally describes a conveying apparatus designed using magnetic levitation technology.

To collect individual products, for example to be able to feed them in groups to a packaging device, circulating compartmented collectors are known. These compartmented collectors have receptacles that open radially outwards. Via a feeding device, the products to be picked up by the compartmented collector are fed lying horizontally on the feeding device. However, it is often necessary to arrange the products upright in order to package them. With the known compartmented collector, this is achieved by rotating them, as a result of which the orientation of the products is essentially turned through 90°.

US 2020/0030995 A1 does not offer a solution for transferring products fed horizontally to a vertical position in a conveying apparatus designed using magnetic levitation technology.

The task of the present invention is to provide such a solution.

According to the invention, this task is solved by a loading apparatus of the type mentioned at the outset, in which the at least one second stator unit can be inclined relative to the at least one first stator unit between the initial position and a final position, the at least one feeding device being arranged in such a way that the at least one product can be transferred by gravity from the respective feeding device into the receptacle of the mover when the latter is in an inclined loading position assigned to the respective feeding device, the inclination angle of which is substantially equal to the inclination angle of the at least one second stator unit arranged in the final position.

It should be noted at this point that the substantially common plane of the first and second movement surfaces can also have small height differences and/or gaps between them, as long as these height differences and/or gaps have no influence on the movement of the mover between the first and second movement surfaces, i.e. have a magnitude that is within the tolerance range of the magnetic levitation technology. Usually, this substantially common plane of the first and second movement surfaces is substantially horizontal.

It should further be noted that two inclination angles are considered to be substantially the same if they differ by no more than an angle by which the movers can in any case be inclined relative to the movement surface of the stator units using the known magnetic levitation technology by changing the magnetic forces.

According to the invention, inclining the mover in the loading position also inclines the receptacle attached to the mover. The angle by which the horizontally fed product must be rotated when it is transferred to the receptacle by the inclination angle of the at least one second stator unit is thereby reduced. This decreases the speed at which the product is transferred to the receptacle. Moreover, its gravity-induced movement into the receptacle is not a pure free fall. Instead, the product slides into the receptacle rather than falling into it. All of this reduces the impact of the product on the floor of the receptacle and thus also lessens the risk of damage to the product in particular.

In order to at least reduce, if not eliminate, slippage of the products on the feeding device and thus be able to feed the products into the receptacle as precisely as possible, the feeding device can be equipped with positioning means. For example, the products can be held on a feed belt of the feeding device by vacuum until the end of the feeding device. The vacuum can suck the products onto the surface of the feed belt through perforations in the belt, for example.

According to the invention, both receptacles which have only a single compartment, in which in particular a plurality of products can be accommodated, and receptacles which have a plurality of compartments, in each of which at least one product can be accommodated, can be used.

When using a receptacle with a plurality of compartments, the at least one mover can be moved in the inclined position while the receptacle is being filled with products. This has the advantage that each product can be transferred to its intended compartment.

Also, when the loading apparatus comprises a plurality of feeding devices, it is advantageous to be able to move the mover during loading in order to be able to arrange the fed products in the receptacle in a desired sequence.

By using different types of movers, for example movers with different dimensions, and/or using different receptacles, for example receptacles with different dimensions and/or different numbers of compartments, the loading apparatus according to the invention can easily be adapted to a variety of product types and/or tasks.

To further reduce the risk of damage to the products in the loading apparatus according to the invention, it is proposed that a section of the at least one feeding device adjacent to the assigned loading position of the mover is inclined relative to the first movement surface of the at least one first stator unit. It has proven to be particularly advantageous if the angle between the at least one inclined feeding device and the second movement surface of the at least one second stator unit in the final position is between approximately 160° and approximately 30°, preferably between approximately 120° and approximately 45°, more preferably approximately 90°.

In a loading apparatus with at least one first stator unit and at least one second stator unit, the at least one loading position can be arranged on the at least one second stator unit. In this case, a loading cycle can proceed as follows:

If the at least one second stator unit is in the initial position, a mover with an empty receptacle can move from the at least one first stator unit to the at least one second stator unit, namely into a loading position. Now the at least one second stator unit is lowered into the final position so that the receptacle can be loaded with the at least one product by actuating the feeding device assigned to the loading position. At the loading position, the mover can move to a number of loading sub-positions which together form the loading position so as to enable a number of products to be picked up. The at least one second stator unit is then pivoted back to the initial position, in which the now filled mover can switch back to the area of the at least one first stator unit.

In order to avoid at least part of the dead time during which the loading process has to be interrupted, it is proposed in a further development of the invention that the at least one second stator unit has sufficient space for the simultaneous arrangement of at least two movers. In this case, the switching of loaded and unloaded movers in the initial position can take place more quickly. While the loaded mover moves from the loading position of the at least one second stator unit to the at least one first stator unit, an unloaded mover can simultaneously move from the at least one first stator unit to the further position of the at least one second stator unit. And while the at least one second stator unit is being lowered, the unloaded mover can switch from the further position to the loading position.

In a further development of the invention, it may further be provided that the loading apparatus further comprises at least one third stator unit having a third movement surface along which the mover can move, wherein the at least one third stator unit has substantially the same inclination as the at least one second stator unit in the final position, with the second movement surface and the third movement surface, when the at least one second stator unit is in the final position, substantially forming a common plane. The at least one third stator unit enables the dead time to be further reduced. In this case, the loading position can be arranged on the at least one third stator unit, while only at least one transfer position is provided on the at least one second stator unit. Therefore, the loading process can be carried out on a mover located in the loading position on the at least one third stator unit, while the last loaded mover is lifted from the at least one second stator unit to the at least one first stator unit, and then another unloaded mover is pivoted from the at least one first stator unit to the at least one second stator unit. The dead time can be reduced particularly effectively, if not avoided altogether, if the at least one second stator unit and the at least one third stator unit each have at least one further position for the arrangement of a mover.

In order to prevent the mover or movers from slipping in the event of a power failure, it is proposed that a stop unit is assigned to the at least one loading position and, where applicable, to the at least one further position. Such a stop unit can, for example, be attached to the at least one second or third stator unit.

To increase the flexibility of use of the loading apparatus according to the invention, it is proposed that the at least one third stator unit can be moved into a position in which the third movement surface substantially forms a common plane with the second movement surface of the at least one second stator unit located in the initial position and the first movement surface of the at least one first stator unit. In this state, the products fed horizontally by the at least one feeding device can also be arranged horizontally in the receptacle of the mover.

The inclination of the at least one second stator unit between the initial position and the final position can be achieved in different ways.

According to a first alternative, the at least one second stator unit can be pivotably connected to the at least one first stator unit about a pivot axis, while according to a second alternative, the at least one second stator unit can be connected to a pivot mechanism whose pivot axis is arranged outside the at least one second stator unit. In the second alternative, the at least one second stator unit can be connected to the pivot mechanism either rigidly or via a joint mechanism.

These two alternatives have the advantage that only one actuator is required to bring about the inclination movement of the at least one second stator unit. In the case of the first alternative, this actuator acts on a point of the at least one second stator unit remote from the pivot axis and can be a linear actuator, for example. In the case of the second alternative, the actuator drives the pivot mechanism.

According to a third alternative, at least two actuators, for example two linear actuators, can be provided, which act on points of the at least one second stator unit that are spaced apart from one another.

Furthermore, at least two actuators, for example two linear actuators, can be provided, which act on points of the at least one third stator unit that are spaced apart from one another.

According to a further aspect, the invention relates to a magnetic levitation conveying apparatus with at least one loading apparatus according to the invention. With regard to the advantages that can be achieved with such a magnetic levitation conveying apparatus, reference is made to the foregoing discussion of the loading apparatus according to the invention.

The invention is explained in more detail below based on exemplary embodiments with reference to the accompanying drawings.

These show the following:

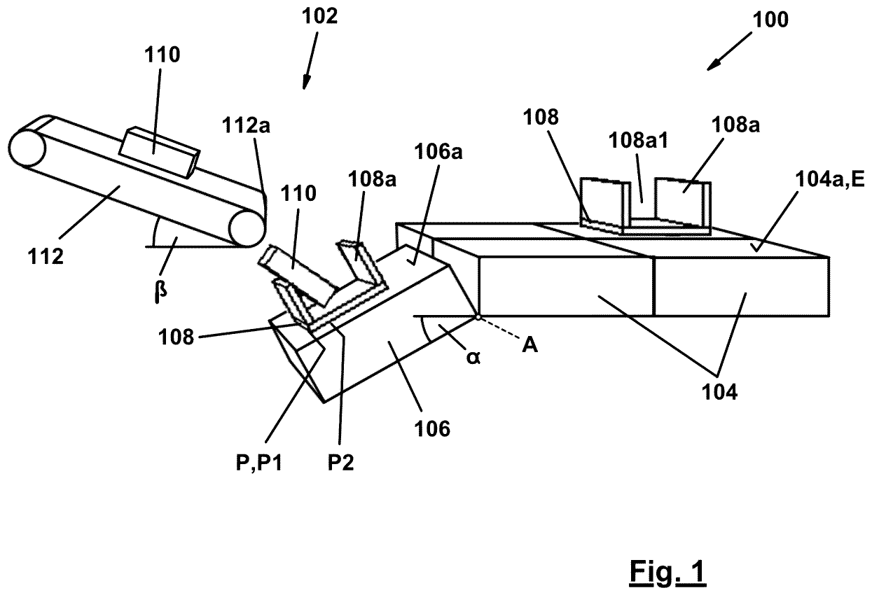

FIG. 1 A schematic representation of a magnetic levitation conveying apparatus according to the invention with a loading apparatus according to the invention.

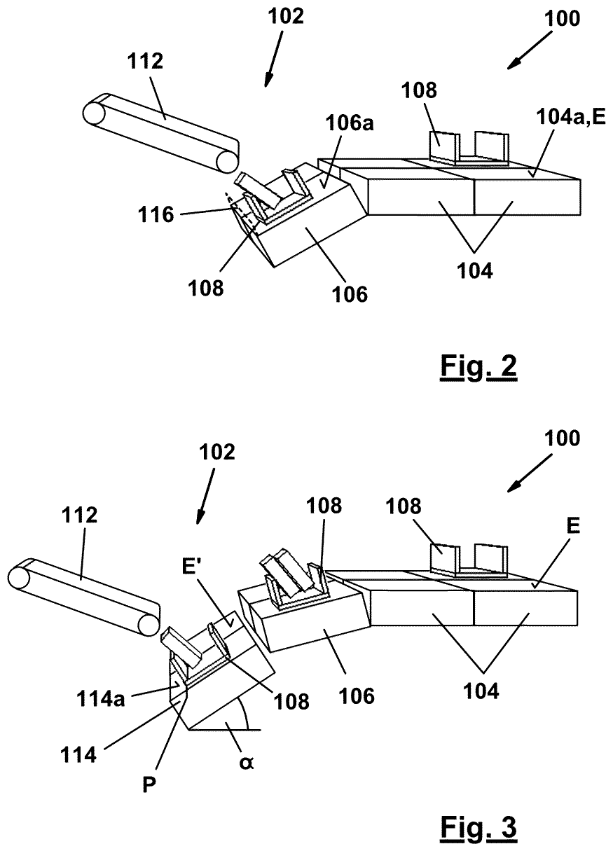

FIG. 2 A schematic representation of a first further development of the magnetic levitation conveying apparatus and the loading apparatus from FIG. 1.

FIG. 3 A schematic representation of a second further development of the magnetic levitation conveying apparatus and the loading apparatus from FIG. 1.

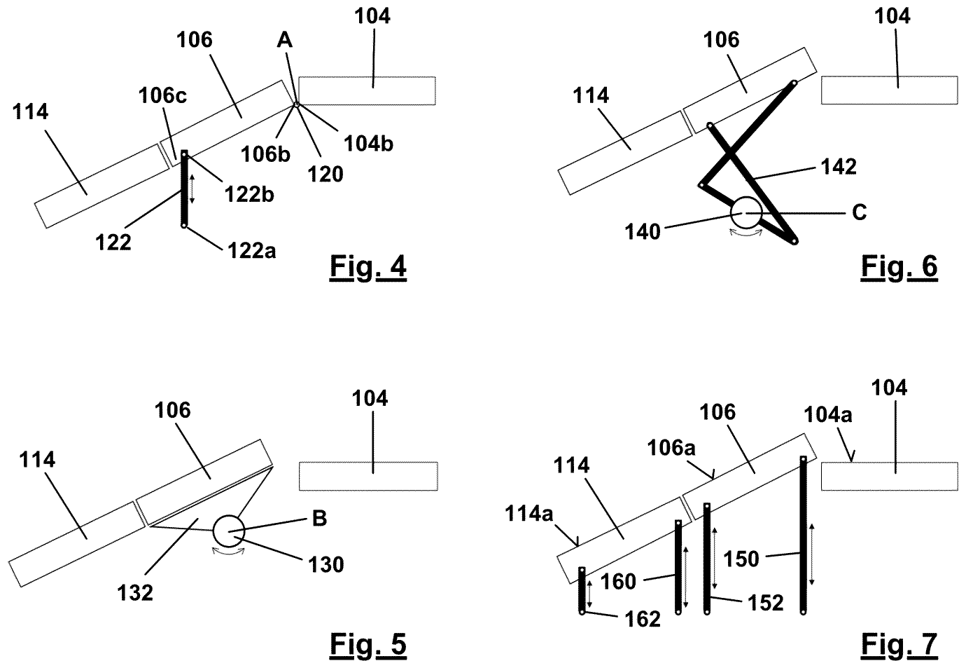

FIGS. 4 to 7 Schematic representations illustrating possible ways to bring about the inclination movement of the at least one second stator unit.

In FIG. 1, a magnetic levitation conveying apparatus is generally designated with the reference number 100. The magnetic levitation conveying apparatus 100 comprises a loading apparatus 102, which in turn comprises a plurality of first stator units 104, a second stator unit 106 and a plurality of movers 108.

As is known per se from US 2020/0030995 A1, a plurality of magnetic coils (not shown here) is arranged in the stator units 104 and 106, which generate a magnetic field moving along the stator units 104, 106. This magnetic field interacts with permanent magnets arranged in the movers 108 (also not shown). As a result, the movers 108 are pulled along by the moving magnetic field and move along the surfaces 104a, 106a of the stator units 104, 106. The surfaces 104a, 106a are also referred to as “movement surfaces” in the context of the present invention.

A receptacle 108a in which a plurality of products 110 can be accommodated is attached to each of the movers 108. In the embodiment of FIG. 1, each receptacle has only one compartment 108a1, and two products 110 can be accommodated in each receptacle 108a. Naturally, however, the invention is not limited to this. Receptacles 108 with a plurality of compartments are also conceivable. Furthermore, any number of products 110 can be accommodated in each compartment.

According to the invention, the second stator unit 106 can be inclined between an initial position, in which its movement surface 106a is substantially flush with the movement surface 104a of the first stator units 104 and forms a common plane E with the latter, and a final position (see FIG. 1). The initial position and the final position of the second stator unit 106 enclose an inclination angle α.

As shown in FIG. 1, the movers 108 can move on the movement surface 106a of the second stator unit 106 into a loading position P, in which the fed products 110 lying horizontally on a feeding device 112 are transferred by gravity from the end 112a of the feeding device 112 into the receptacle 108a, where they assume a substantially vertical position. More precisely, the loading position P comprises a separate loading sub-position for each product 110 that is to be accommodated in the receptacle 108a. In the illustrated exemplary embodiment, two loading sub-positions P1 and P2 are thus provided.

If the mover 108, which is currently in the loading position, has been completely filled, the second stator unit 106 is tilted from its final position to the initial position, so that the movement surfaces 104a, 106a of the first and second stator units 104, 106 form a common plane E. In this state, the loaded mover 108 can move from the second stator unit 106 onto the first stator units 104 and thus make room for an unloaded mover 108, which moves from the first stator units 104 to the second stator unit 106. The second stator unit 106 can then be tilted from its initial position to the final position to enable the unloaded mover 108 to be loaded.

It should be added that a section of the feeding device 112 adjacent to the loading position P is also inclined in the illustrated exemplary embodiment, namely by an inclination angle β. In this way, the horizontally fed products 110 only need to be rotated by an angle of (90°−α−β) in order to transfer them to an upright or vertical position relative to the receptacle 108a.

In the further development of FIG. 2, the loading apparatus 102 comprises a plurality of second stator units 106, which can be tilted together between the initial position and the final position. Although for the sake of clarity only two second stator units 106 are shown in FIG. 2, three or more second stator units 106 could also be provided. The at least one additional second stator unit ensures that there is always sufficient space for two movers 108 on the second stator units 106.

This means, for example, that when the mover 108 that has just been loaded by the feeding device 112 moves from one second stator unit 106 to the first stator units 104 with the second stator units 106 in the initial position, an unloaded mover 108 can simultaneously move from the first stator units 104 to the other second stator unit 106. This simultaneous switching of the position of the two movers shortens the duration of the loading cycle. While the second stator unit 106 is tilted from its initial position to the final position, the unloaded mover 108 can switch to the loading position.

A further reduction in the duration of the loading cycle can be achieved by the further development of FIG. 3, according to which the loading apparatus 102 further comprises third stator units 114 on whose third movement surface 114a the mover 108 can move using magnetic levitation technology. The third stator units 114 are arranged inclined relative to the first stator units 104, namely by the same inclination angle α that the second stator units 106 assume in the final position relative to the first stator units 104. Furthermore, the third stator units 114 are arranged such that they substantially form a common plane E′ with the second stator units 106 when these are in the final position. In this further development, the loading position P is located in the area of the third stator units 114.

In FIG. 3, the second stator units 106 are shown in an intermediate position between the final position and the initial position. The mover 108 located on the second stator units 106 has just been loaded by the feeding device 112 and then switched from the third stator units 114 to the second stator units 106 when these were in their final position. At the same time, in this final position, an unloaded mover 108 has switched from the second stator units 106 to the third stator units 114 and has moved to the loading position P there. While this mover 108 is being loaded, the second stator units 106 in the initial position transfer the loaded mover 108 onto the first stator units 104 and take over the next unloaded mover from these.

Where appropriate, at least one waiting position (not shown), in which loaded movers 108 can wait for the second stator units 106 to return to their final position, can also be provided on the third stator units 114 after the loading position P. Similarly, more than one intermediate position for unloaded movers 108 can also be provided on the third stator units 114 before the loading position P. Naturally, in this case the second stator units 106 must have a corresponding number of positions for movers 108.

At this point it should be added that stop units can be attached to the second stator units 106 of FIGS. 1 and 2 and the third stator units 114 of FIG. 3, whereby, for example in the event of a power failure, the mover 108 can be prevented from sliding off the respective inclined movement surface 106a or 114a. An example of such a stop unit 116 is roughly schematically illustrated in FIG. 2.

It should further be noted that the first further development according to FIG. 2 and the second further development according to FIG. 3 can be realized in a simple way by adding further stator units 106 and/or 108 in the arrangement described in each case and adapting the software for controlling the movement of the movers 108 based on the embodiment of FIG. 1.

The tilting of the second stator units 106 between the initial position and the inclined final position can be achieved in different ways. With reference to FIGS. 4 to 7, four possibilities are described, without this being understood as an exhaustive list of all conceivable possibilities.

The tilt option shown in FIG. 4 substantially corresponds to that which is also used in FIGS. 1 to 3, even if it is not shown in such detail there. According to this tilt option, the first stator units 104 and the second stator unit 106 or the second stator units 106 are hinged to one another along two adjacent edges 104b and 106b by means of a hinge 120. The pivot axis is labelled A in FIG. 4. Furthermore, at least one linear actuator 122 is provided, which is in control engagement with the second stator unit 106 or the second stator units 106 of the opposite edge 106c adjacent thereto. The linkage points of the actuator 122 on a frame of the loading apparatus 102 and on the second actuator 106 or the second actuators 106 are labelled 122a and 122b respectively in FIG. 4.

In contrast, the tilt option shown in FIG. 5 utilizes a rotary actuator 130 which is connected to the second stator unit 106 or the second stator units 106 via a mounting 132. The pivot axis of the rotary actuator 130 is labelled B in FIG. 5.

A rotary actuator 140 is also used for the tilt option shown in FIG. 6. In contrast to FIG. 5, however, this is connected to the second stator unit 106 or the second stator units 106 via a joint mechanism 142, which takes up rather less installation space. The pivot axis of the rotary actuator 140 is labelled C in FIG. 6.

Finally, in the case of the tilt option shown in FIG. 7, two linear actuators 150, 152 are provided, which are linked at one end to the frame of the loading apparatus 102 and at the other end to the second stator unit 106 or to the second stator units 106.

FIG. 7 also shows two corresponding linear actuators 160, 162 for the third stator unit 114 or the third stator units 114, which make it possible to tilt the third stator unit 114 or the third stator units 114 in such a way that their movement surface 114a forms a common plane E with the movement surface 106a of the second stator unit 106 or the second stator units 106 on the one hand, and with the movement surface 104a of the first stator units 104 on the other hand (see FIG. 3). These linear actuators 160, 162 can of course also be used in the same way for the tilt options shown in FIGS. 4 to 6.

1. Loading apparatus for loading a receptacle attached to a mover with at least one product not belonging to the loading apparatus, wherein the mover is part of a conveying apparatus designed using magnetic levitation technology, the loading apparatus comprising:
the mover (108) with the receptacle attached thereto;
at least one feeding device for feeding the at least one product;
at least one first stator unit with a first movement surface along which the mover can move; and
at least one second stator unit with a second movement surface along which the mover can move,
wherein, in an initial position, the at least one first stator unit and the at least one second stator unit are arranged relative to one another such that the first movement surface and the second movement surface substantially form a common plane,
wherein the at least one second stator unit can be inclined relative to the at least one first stator unit between the initial position and a final position,
wherein the at least one feeding device is arranged such that the at least one product can be transferred by gravity from the respective feeding device into the receptacle of the mover when the latter is in an inclined loading position assigned to the respective feeding device, the inclination angle of which is substantially equal to the inclination angle of the at least one second stator unit arranged in the final position.

2. Loading apparatus according to claim 1,
wherein a section of the at least one feeding device adjacent to the assigned loading position of the mover is inclined relative to the first movement surface of the at least one first stator unit.

3. Loading apparatus according to claim 2,
wherein the angle-between the at least one inclined feeding device and the second movement surface of the at least one second stator unit in the final position is between approximately 160° and approximately 30°.

4. Loading apparatus according to claim 1,
wherein the at least one second stator unit has sufficient space for the simultaneous arrangement of at least two movers.

5. Loading apparatus according to claim 1,
further comprising at least one third stator unit with a third movement surface along which the mover can move,
wherein the at least one third stator unit has substantially the same inclination as the at least one second stator unit in the final position, and
wherein the second movement surface and the third movement surface substantially form a common plane when the at least one second stator unit is in the final position.

6. Loading apparatus according to claim 5,
wherein the at least one third stator unit has sufficient space for the simultaneous arrangement of at least two movers.

7. Loading apparatus according to claim 1, wherein a stop unit is assigned to the at least one loading position and, where applicable, to the at least one further position.

8. Loading apparatus according to claim 5,
wherein the at least one third stator unit can be moved into a position in which the third movement surface substantially forms a common plane with the second movement surface of the at least one second stator unit and the first movement surface of the at least one first stator unit.

9. Loading apparatus according to claim 1,
wherein the at least one second stator unit is pivotably connected to the at least one first stator unit about a pivot axis.

10. Loading apparatus according to claim 9,
wherein an actuator acts on a point of the at least one second stator unit remote from the pivot axis.

11. Loading apparatus according to claim 1,
wherein the at least one second stator unit is connected to a pivot mechanism whose pivot axis is arranged outside the at least one second stator unit.

12. Loading apparatus according to claim 10,
characterized in that an actuator is provided for pivoting the pivot drive.

13. Loading apparatus according to claim 1,
wherein at least two actuators are provided which act on points of the at least one second stator unit that are spaced apart from one another.

14. Loading apparatus according to claim 8,
wherein at least two actuators are provided which act on points of the at least one third stator unit that are spaced apart from one another.

15. Magnetic levitation conveying apparatus comprising at least one loading apparatus according to claim 1.
